(19) United States
(12) Patent Application Publication
(10) Pub. No.: US 2009/0314603 A1
(43) Pub. Date: Dec. 24, 2009

(54) DRIVE LUG FOR A TORQUE CONVERTER COVER

(75) Inventor: Patanjali PERI, Copley, OH (US)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/488,957

(22) Filed: Jun. 22, 2009

Related U.S. Application Data
(60) Provisional application No. 61/132,825, filed on Jun. 23, 2008.

(51) Int. Cl. F16D 13/60; F16B 37/06; B23P 11/00

(52) U.S. Cl. 192/112; 411/171; 29/525.11

(57) ABSTRACT

A drive lug for a torque converter cover, including: a central portion including first and second substantially opposite sides, first and second substantially opposite ends, a threaded opening for receiving a fastener, and a first width between the first and second sides; and first and second wing sections extending length-wise from the first and second ends, respectively. The first and second wing sections have second and third widths, respectively. Respective minimum extents of the second and third widths are less than a minimum extent of the first width. In one embodiment, respective maximum extents of the second and third widths are less than a maximum extent of the first width.

### CROSS-REFERENCE TO RELATED APPLICATIONS

This application claims the benefit under 35 U.S.C. §119(e) of U. S. Provisional Application No. 61/132,825 filed on Jun. 23, 2008, which application is incorporated herein by reference in its entirety.

### FIELD OF THE INVENTION

The invention relates to a drive lug for a torque converter and a torque converter cover with the drive lug attached. Specifically, the invention relates to configuring a drive lug to reduce stresses on the cover due to welding of the lug to the cover.

### BACKGROUND OF THE INVENTION

U.S. Pat. No. 6,926,131 discloses a lug welded to a radius, or curved surface, of a cover plate for a torque converter. The radius has residual stresses due to forming of the cover. Welding lugs in the cover radius creates heat affected zones, exacerbating the residual stresses in the cover. Unfortunately, when force is applied to the lugs, for example, during operation of the torque converter, the heat affected areas of the cover radius degrade rapidly.

Thus, there is a long-felt need for a means of reducing stresses associated with welding drive lugs to torque converter covers.

### BRIEF SUMMARY OF THE INVENTION

The present invention broadly comprises a drive lug for a torque converter cover, including: a central portion including first and second substantially opposite sides, first and second substantially opposite ends, a threaded opening for receiving a fastener, and a first width between the first and second sides; and first and second wing sections extending length-wise from the first and second ends, respectively. The first and second wing sections have second and third widths, respectively. Respective minimum extents of the second and third widths are less than a minimum extent of the first width. In one embodiment, respective maximum extents of the second and third widths are less than a maximum extent of the first width.

The present invention also broadly comprises drive lugs and cover for a torque converter, including a cover with a flat annular surface; a plurality of drive lugs; and respective welds connecting each lug in the plurality of lugs to the flat annular surface. Each drive lug from the plurality of drive lugs includes: a central portion including first and second substantially opposite sides, first and second substantially opposite ends, a threaded opening for receiving a fastener, and a first width between the first and second sides; and first and second wing sections extending length-wise from the first and second ends. At least first and second portions of the first and second wing sections, respectively, taper widthwise with respect to the first and second ends, respectively, the at least first and second portions have second and third widths, respectively, and respective minimum extents of the second and third widths are less than a minimum extent of the first width.

In one embodiment, respective maximum extents of the second and third widths are less than a maximum extent of the first width. In another embodiment, the flat annular surface has a radial width, the respective welds have respective maximum radial widths, and the respective maximum radial widths are no greater than the radial width of the flat annular surface.

The present invention further broadly comprises a method for assembling a torque converter cover.

It is a general object of the present invention to provide a drive lug to reduce stresses on a torque converter cover due to welding of the lug to the cover.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a perspective view of a present invention drive lug;

FIG. 3 a top view of the drive lug shown in FIG. 2;

FIG. 4 a cross-sectional view of the drive lug shown in FIG. 2, generally along line 4-4 in FIG. 3;

FIG. 5 is a perspective view of a present invention lug and cover;

FIG. 6 a top view of the lug and cover shown in FIG. 5; and,

FIG. 7 a cross-sectional view of the lug and cover shown in FIG. 5, generally along line 7-7 in FIG. 6.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

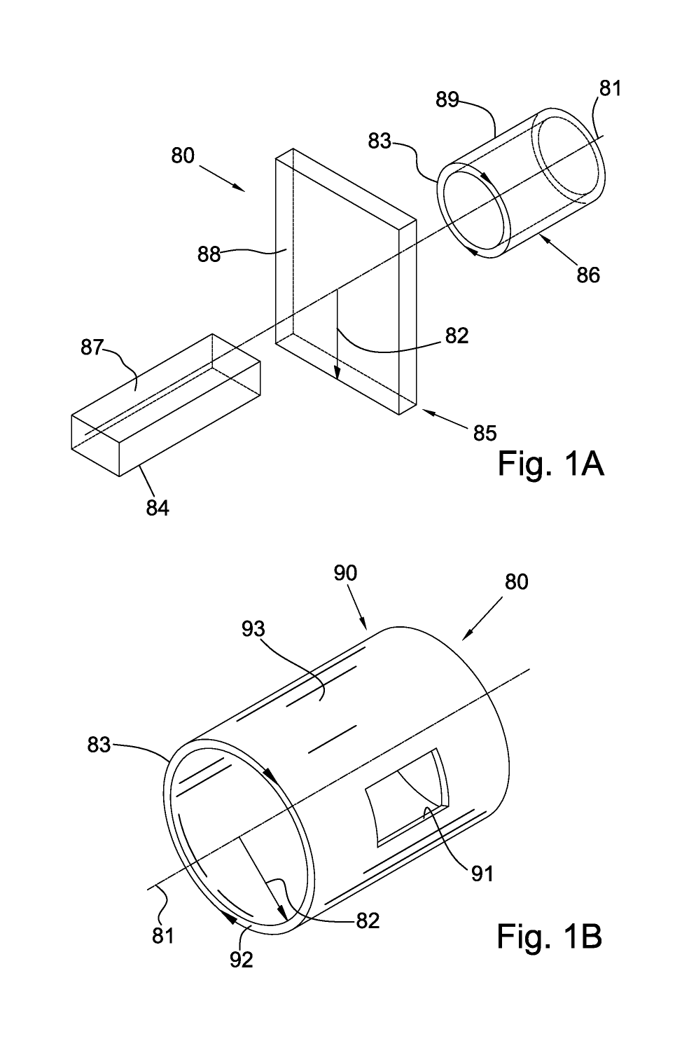

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

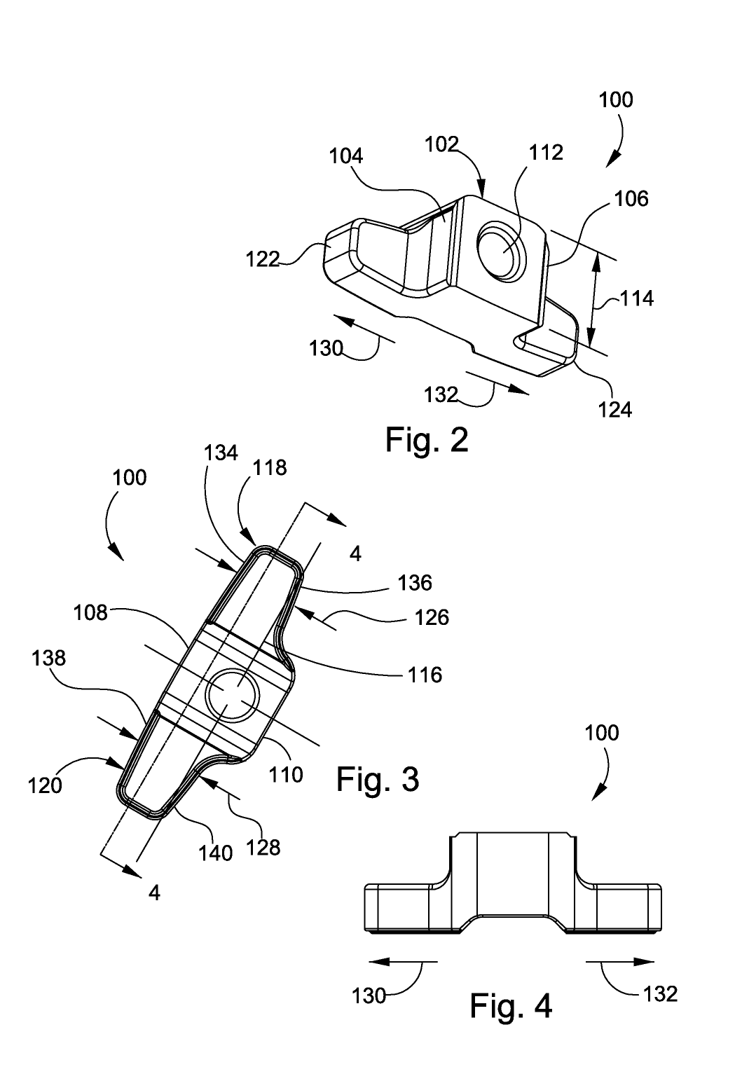

FIG. 2 is a perspective view of present invention drive lug 100.

FIG. 3 a top view of drive lug 100 shown in FIG. 2.

FIG. 4 a cross-sectional view of drive lug 100 shown in FIG. 2, generally along line 4-4 in FIG. 3. The following should be viewed in light of FIGS. 2 through 4. Lug 100 includes central portion 102 with substantially opposite ends 104 and 106, substantially opposite sides 108 and 110, threaded opening 112 for receiving a fastener (not shown), and width 114. For example, width 114 can be taken anywhere along a line orthogonal to center line 116 for opening 112. Wing sections 118 and 120 extend length-wise from ends 104 and 106, respectively. At least portions of wing sections 118 and 120, respectively, taper width-wise with respect to ends 104 and 106, respectively. That is, as the wing sections extend from the center portion, at least a portion of the wing sections tapers, for example, narrows widthwise. In one embodiment, wing sections 118 and 120 taper continuously from the center section to ends 122 and 124, respectively. In this case, the respective portions of the wing sections that taper include the entire wing section. Alternately stated, the portions of wing sections 118 and 120 that taper have widths 126 and 128, respectively, and these widths decrease along respective portions moving in a direction from the center portion toward ends 122 and 124, respectively, for example, in directions 130 and 132, respectively. For example, widths 126 and 128 can be taken anywhere along a line orthogonal to center line 116 for opening 112. One or both of sides 134 and 136 of wing sections 118 can taper. One or both of sides 138 and 140 of wing sections 120 can taper, for example, with respect to line 116. Any combination of tapers between wing sections 118 and 120 is included in the spirit and scope of the claimed invention.

In another embodiment (not shown), wing sections 118 and 120 do not taper continuously toward ends 122 and 124. For example, respective widths of the wing sections may increase at some point moving along the wing sections in directions 130 and 132. Alternately stated, the wing sections “bulge” widthwise. In one embodiment, respective minimum extents of widths 122 and 124 are less than a minimum extent of width 114. In another embodiment, respective maximum extents of widths 122 and 124 are less than a maximum extent of width 114. Thus, at least some portion of the wing sections has a width less than the width of the center section.

In general, lug 100 is arranged to be welded to a cover (not shown) for a torque converter (not shown), as described infra. Portions of the wing sections are arranged to be welded to the cover, in particular, those portions of the wing sections having a width less than the width of the center portion.

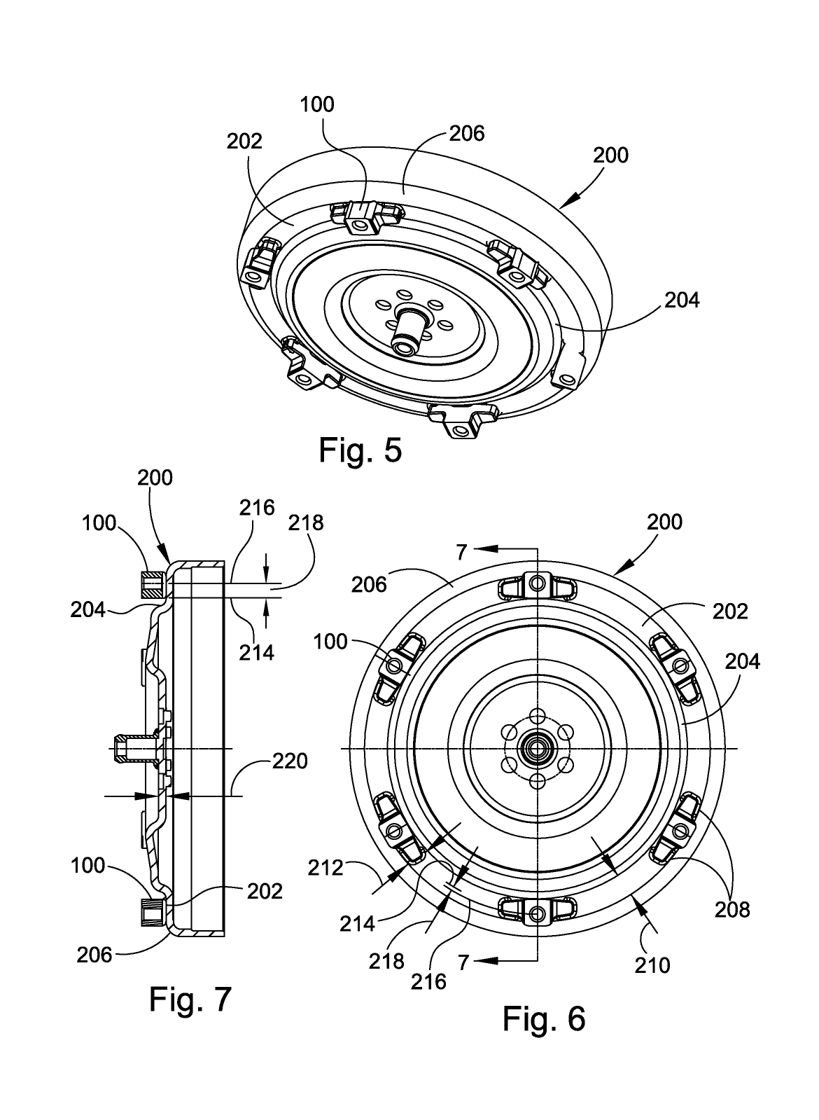

FIG. 5 is a perspective view of a present invention lug and cover.

FIG. 6 a top view of the lug and cover shown in FIG. 5.

FIG. 7 a cross-sectional view of the lug and cover shown in FIG. 5, generally along line 7-7 in FIG. 6. The following should be viewed in light of FIGS. 2 through 7. Cover 200 includes flat annular surface 202 and annular surfaces 204 and 206, continuous with the flat annular surface. That is, surfaces 202 and surfaces 204 and 206 are connected, for example, the surfaces are part of a single cover. Surface 204 is disposed radially inside the flat annular surface and curved in an axial direction. Surface 206 is disposed radially outside the flat annular surface and curved in an axial direction. For example, the axial curve of surfaces 204 and 206 is shown in FIG. 7. The axial curve is parallel to a plane formed by the sheet for FIG. 7. A plurality of drive lugs 100 is connected to cover 200 with respective welds 208. The respective welds connect the lugs to the flat annular surface and overlap between the welds and surfaces 204 and/or 206 is minimized. In one embodiment, the weld is restricted to contact with the lug and the flat annular surface. In another embodiment, the welds are restricted to the wing sections of the lugs.

The shape of lugs 100, noted supra, enables the minimization or elimination of contact between the welds and surfaces 204 and 206. For example, in one embodiment, the flat annular surface has radial width 210 and the respective welds have respective maximum radial widths 212 no greater than radial width 208. Thus, overlap between the lug and surfaces 204 and 206 is minimized or eliminated, which in turn minimizes or eliminates contact between the welds and surfaces 204 and 206. Lug 100 can be positioned on cover 200 to accommodate various orientations of bolts or fasteners for a flexplate (not shown) to which cover 200 is to be connected, while still minimizing or eliminating contact between the welds and surfaces 204 and 206. For example, it is common for a cover, in particular, lugs for the cover, to be adapted to the configuration of the flexplate. One aspect of the configuration of the flexplate fasteners is the radial position of the fasteners, which dictates the radial position of openings 112. That is, openings 112 must be radially positioned to axially align with/accept the fasteners. Advantageously, since widths 126 and/or 128 are less than width 114, the radial position of opening 112 can be adjusted while still minimizing or eliminating overlap of lugs 100 with surfaces 204 and 206. For example, as shown in FIG. 6, radially centered line 214 for the flat annular surface is radially offset from radially centered line 216 for openings 112 by amount 218, for example, to axially align the openings with flexplate fasteners (not shown). Thus, the opening is located sufficiently radially outward to accommodate the fasteners (which in this case requires the openings to be off-center with respect to line 214) while still minimizing or eliminating overlap of portions 118 and/or 120 with surface 206, since the respective widths of portions 118 and 120 are reduced. The above discussion also is applicable to cases in which openings 112 are centered radially inside of line 214.

Advantageously, by limiting or eliminating the contact between the welds and surfaces 204 and 206, heating of surfaces 204 and 206 by application of the welds is minimized, and stresses associated with such heating also are minimized. Thus, the strength and durability of the cover are increased without the need to otherwise modify the cover, for example, by increasing thickness 220 of the cover.

The following should be viewed in light of FIGS. 2 through 7. The following describes a present invention method for assembling a cover for a torque converter. Although the method is presented as a sequence of steps for clarity, no order should be inferred from the sequence unless explicitly stated. A first step forms a plurality of drive lugs, each lug from the plurality of lugs including: a central portion including first and second substantially opposite sides, first and second substantially opposite ends, a threaded opening for receiving a fastener, and a first width between the first and second sides; and first and second wing sections extending length-wise from the first and second ends. At least first and second portions of the first and second wing sections, respectively, taper widthwise with respect to the first and second ends, respectively, the at least first and second portions have second and third widths, respectively, and respective minimum extents of the second and third widths are less than a minimum extent of the first width. A second step places each drive lug from the plurality of drive lugs in contact with a flat annular surface of the cover; and a third step welds the first and second ends for said each lug to the flat annular surface.

In one embodiment, the cover includes a first annular surface continuous with the flat annular surface, disposed radially inside the flat annular surface, and curved in an axial direction and a second annular surface continuous with the flat annular surface, disposed radially outside the flat annular surface, and curved in an axial direction. In another embodiment, the flat annular surface has a radial width and a fourth step restricts respective maximum radial widths for the welds to be no greater than the radial width. In a further embodiment, a fifth step restricts contact between welds and the cover to the flat annular region.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A drive lug for a torque converter cover, comprising:
a central portion including first and second substantially opposite sides, first and second substantially opposite ends, a threaded opening for receiving a fastener, and a first width between the first and second sides; and,
first and second wing sections extending length-wise from the first and second ends, wherein at least first and second portions of the first and second wing sections, respectively, taper widthwise with respect to the first and second ends, respectively, wherein the at least first and second portions have second and third widths, respectively, and wherein respective minimum extents of the second and third widths are less than a minimum extent of the first width.

2. The drive lug of claim 1, wherein the respective maximum extents of the second and third widths are less than a maximum extent of the first width.

3. Drive lugs and cover for a torque converter, comprising:
a cover including a flat annular surface;
a plurality of drive lugs, wherein each drive lug from the plurality of drive lugs includes:
a central portion including first and second substantially opposite sides, first and second substantially opposite ends, a threaded opening for receiving a fastener, and a first width between the first and second sides; and,
first and second wing sections extending length-wise from the first and second ends, wherein at least first and second portions of the first and second wing sections, respectively, taper widthwise with respect to the first and second ends, respectively, wherein the at least first and second portions have second and third widths, respectively, and wherein respective minimum extents of the second and third widths are less than a minimum extent of the first width; and,
respective welds connecting each lug in the plurality of lugs to the flat annular surface.

4. The drive lugs and cover of claim 3, wherein respective maximum extents of the second and third widths are less than a maximum extent of the first width.

5. The drive lugs and cover of claim 3 wherein the flat annular surface has a radial width, the respective welds have respective maximum radial widths, and the respective maximum radial widths are no greater than the radial width of the flat annular surface.

6. A method for assembling a torque converter cover, comprising:
forming a plurality of drive lugs, each lug from the plurality of lugs including:
a central portion including first and second substantially opposite sides, first and second substantially opposite ends, a threaded opening for receiving a fastener, and a first width between the first and second sides; and,
first and second wing sections extending length-wise from the first and second ends, wherein at least first and second portions of the first and second wing sections, respectively, taper widthwise with respect to the first and second ends, respectively, wherein the at least first and second portions have second and third widths, respectively, and wherein respective minimum extents of the second and third widths are less than a minimum extent of the first width;
placing each drive lug from the plurality of drive lugs in contact with a flat annular surface of the cover; and,
welding the first and second ends for said each lug to the flat annular surface.

7. The method of claim 6 wherein the cover includes a first annular surface continuous with the flat annular surface, disposed radially inside the flat annular surface, and curved in an axial direction and a second annular surface continuous with the flat annular surface, disposed radially outside the flat annular surface, and curved in an axial direction.

8. The method of claim 6 wherein the flat annular surface has a radial width and the method including restricting respective maximum radial widths for the welds to be no greater than the radial width.
